(19) United States
(12) Patent Application Publication
(10) Pub. No.: US 2011/0094549 A1
(43) Pub. Date: Apr. 28, 2011

(54) CLEANING SYSTEM FOR SOLAR PANEL

(75) Inventor: I-THUN LIN, Tu-Cheng (TW)

(73) Assignee: HON HAI PRECISION INDUSTRY CO., LTD., Tu-Cheng (TW)

(21) Appl. No.: 12/691,885

(22) Filed: Jan. 22, 2010

(30) Foreign Application Priority Data
Oct. 28, 2009 (CN) 200910308953.3

(51) Int. Cl. B08B 3/00

(52) U.S. Cl. 134/198

(57) ABSTRACT

A cleaning system for solar panels includes a number of solar cells and a transparent protection pane covering the solar cells. The cleaning system includes a frame, a cleaning device, and an operating device. The frame includes a first sidewall and a opposite second sidewall facing away from the first sidewall. The cleaning device is affixed on the transparent protection panel. The operating device includes a motor, a pulley and a belt. The motor is affixed on one end of the first sidewall. The pulley is affixed on the other end of the first sidewall. The belt is wrapped around the rotating shaft of the motor and the pulley. The cleaning device includes an axle connected to the operating device and a washer provided on the axle. The cleaning device is driven by the operating device to clean the solar panel.

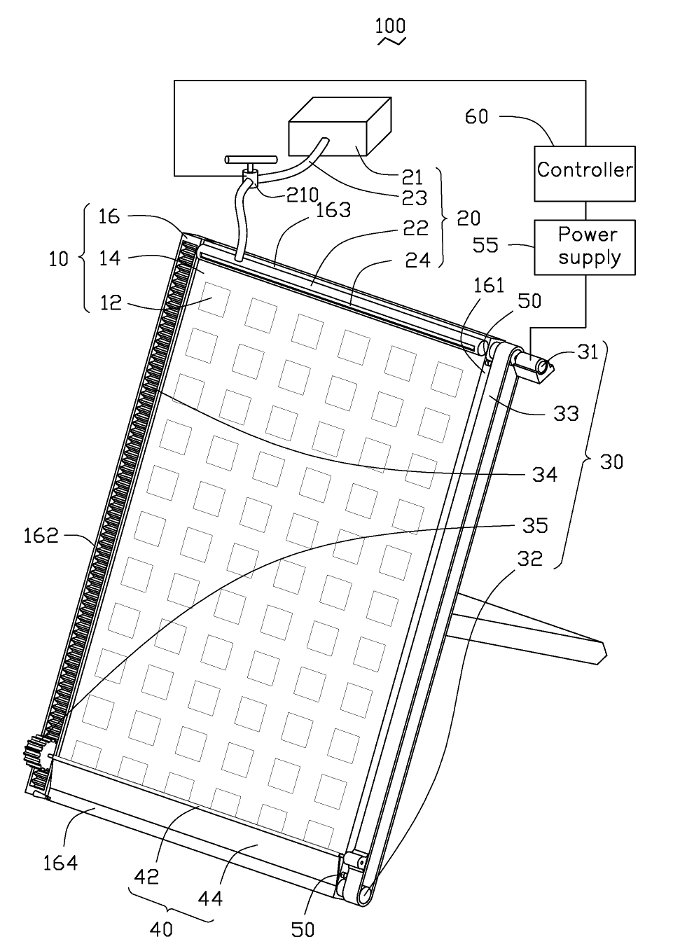

### BACKGROUND

1. Technical Field

The present disclosure relates to a cleaning system and, particularly, to a cleaning system for a solar panel.

2. Description of the Related Art

Nowadays, with more resources on the earth being consumed everyday, the cost of investment for energy has increased significantly. Solar energy has drawn attention from the energy industry as an alternative source of energy, and has widespread applications in a variety of fields.

Outdoor solar panels tend to accumulate dirt. This creates a need for frequent cleaning. Even a thin coating of dust or dirt can seriously affect the efficiency of photovoltaic energy production. Although, there are some cleaning systems for solar panels, those structures are complex and costly. In addition users must manually control the cleaning system booting up or shutting off, which is inconvenient.

Therefore, it is desirable to provide a solar panel cleaning system, which can overcome the described limitations.

### BRIEF DESCRIPTION OF THE DRAWING

Many aspects of the present cleaning system for solar panel could be better understood with reference to the accompanying drawing. The components in the drawing are not necessarily drawn to scale, the emphasis instead being placed upon clearly illustrating the principles of the cleaning system for solar panel. Moreover, in the drawing, like reference numerals designate corresponding parts throughout the Drawing.

The drawing is an assembled, isometric view of a cleaning system for solar panel, according to an exemplary embodiment.

### DETAILED DESCRIPTION

Embodiments of the present cleaning system for solar panel is now described in detail with reference to the drawing.

Referring to the drawing, an automatic cleaning system 100 for cleaning a solar panel 10 includes a frame 16, spraying device 20, an operating device 30, a cleaning device 40 for cleaning the solar panel 10, and a controller 60 for controlling the automatic cleaning system 100 working. The solar panel 10 includes a number of solar cells 12 and a transparent protection panel 14 covering the solar cells 12.

The frame 16 encloses the solar panel 10. In this embodiment, the frame 16 is rectangular in shape and includes a first sidewall 161, a second sidewall 162 parallel to and facing away from the first sidewall 161, a top sidewall 163 perpendicularly connected to the first sidewall 161 and the second sidewall 162, and a bottom sidewall 164 parallel to and facing away from the top sidewall 163.

The spraying device 20 includes a tank 21, a sprinkler 22 affixed to the top sidewall 163, and a pipe 23 connected between the tank 21 and the sprinkler 22. The tank 21 stores cleaning fluid, such as a water and cleaning agent mixture. An electromagnetic valve 210 is affixed to the pipe 23, and is configured for regulating the cleaning fluid flowing from the tank 21 to the sprinkler 22. An outlet 24 is defined in the sprinkler 22 used to sprinkle or flow the cleaning fluid from the tank 21 onto the transparent protection panel 14.

The operating device 30 includes a motor 31, a pulley 32, a belt 33, a rack 34, and a gear wheel 35. In this embodiment, the motor 31 is disposed on one end of the first sidewall 161, close to the top sidewall 163. To receive power, the motor 31 is electrically coupled to a power supply 55. The power supply 55 may obtain power from the solar panel 10. The pulley 32 is affixed to the opposite end of the first sidewall 161, close to the bottom sidewall 164. The belt 33 is wrapped around a rotating shaft of the motor 31 and the pulley 32. The rack 34 is formed on the first sidewall 162. The gear wheel 35 is geared with the rack 34.

The cleaning device 40 includes a holding axle 42 and a washer 44 configured on the axle 42. One end of the axle 42 is affixed on the belt 33 and the other end is rotatably coupled to the gear wheel 35. The motor 31 drives the belt 33 to move along the first sidewall 161, and the belt 33 moves the axle 42 and the washer 44 along the transparent protection panel 14.

In this embodiment, the automatic cleaning system 100 further includes two electromagnetic clutches 50. The two electromagnetic clutches 50 are positioned between two opposite ends of the first sidewall 161 limiting movement of the axle 42, and are electrically coupled to the motor 31 for changing the polarity of power from the power supply 55, thus running the motor 31 in reverse. In detail, when the axle 42 contacts one of the two electromagnetic clutches 50, the electromagnetic clutch 50 changes the power polarity of the power supply 55 to run the motor 31 in reverse and the axle 42 returns. As a result, the washer 44 moves along the transparent protection panel 14 back and forth to clean the transparent protection panel 14.

The controller 60 is electrically coupled to the power supply 55 and the electromagnetic valve 210. The controller 60 periodically controls and operates the cleaning system 100 cleaning the solar panel 10, for example, every one to two days or as required. In detail, the controller 60 periodically controls the electromagnetic valve 210 to open. Thereby, supplying a continuous flow, when activated, of cleaning fluid from the tank 21 to the sprinkler 22, and the outlet 24 allows the cleaning fluid to sprinkle or flow onto the transparent protection panel 14. At the same time, the controller 60 periodically controls the power supply 55. The motor 31 drives the belt 33 to move along the first sidewall 161, and the belt 33 moves the axle 42 and the washer 44 on the transparent protection panel 14 to clean the solar panel 10. After a set time period, such as 2 minutes, the controller 60 shuts off the cleaning system 100.

It will be understood that the above particular embodiments and methods are shown and described by way of illustration only. The principles and the features of the present disclosure may be employed in various and numerous embodiments, without departing from the scope of the disclosure as claimed. The above-described embodiments illustrate the scope of the disclosure but do not restrict the scope of the disclosure.

What is claimed is:

1. A cleaning system for a solar panel, the solar panel comprising a plurality of solar cells and a transparent protection panel covering the solar cells, the cleaning system comprising:
a frame comprising a first sidewall and a second sidewall facing away from the first sidewall;
a cleaning device disposed on the transparent protecting panel; and
an operating device comprising a motor having a rotating shaft, a pulley, a belt, a rack, and a gear wheel, the motor disposed on one end of the first sidewall, the pulley affixed to the opposite end of the first sidewall, the belt wrapped around the rotating shaft of the motor and the pulley, the rack formed on the second sidewall, the gear wheel geared with the rack, wherein the cleaning device comprises an axle and a washer, the axle is connected between the belt and the gear wheel, the washer is configured on the axle, the operating device configured to drive the cleaning device to clean the solar panel.

2. The cleaning system as claimed in claim 1, further comprising two electromagnetic clutches and a power supply for the motor, wherein the two electromagnetic clutches are positioned between opposite ends of the first sidewall, and are electrically coupled to the power supply for changing the polarity of power from the power supply, to cause the motor to rotate in reverse.

3. The cleaning system as claimed in claim 2, further comprising a controller, wherein the controller is electrically coupled to the power supply and configured for periodically switching on the cleaning system cleaning the solar panel.

4. The cleaning system as claimed in claim 2, wherein the power supply is configured for obtaining power from the solar panel.

5. The cleaning system as claimed in claim 1, wherein the belt is configured for moving the axle and the washer on the transparent protection panel.

6. A cleaning system for a solar panel, the solar panel comprising a plurality of solar cells and a transparent protection panel covering the solar cells, the cleaning system comprising:
a frame comprising a first sidewall, an opposing second sidewall facing away from the first sidewall, and a top sidewall perpendicularly connected to the first and second sidewall;
a cleaning device disposed on the transparent protecting panel;
a spraying device comprising a tank for storing cleaning fluid, a sprinkler, and a pipe connected between the tank and the sprinkler, the sprinkler affixed on the top sidewall, the sprinkler configured for sprinkling the cleaning fluid onto the transparent protection panel; and
an operating device comprising a motor having a rotating shaft, a pulley, a belt, a rack, and a gear wheel, the motor disposed on one end of the first sidewall, the pulley affixed to the opposite end of the first sidewall, the belt wrapped around the rotating shaft of the motor and the pulley, the rack formed on the second sidewall, the gear wheel geared with the rack, wherein the cleaning device comprises an axle and a washer, the axle is connected between the belt and the gear wheel, the washer is configured on the axle, the operating device configured to drive the cleaning device to clean the solar panel.

7. The cleaning system as claimed in claim 8, wherein an electromagnetic valve is affixed to the pipe and configured for regulating the cleaning fluid flowing from the tank to the sprinkler.

8. The cleaning system as claimed in claim 7, further comprising two electromagnetic clutches and a power supply of the motor, wherein the two electromagnetic clutches are positioned between two opposite ends of the first sidewall, and are electrically coupled to the power supply for changing the polarity of power from the power supply, to cause the motor to rotate in reverse.

9. The cleaning system as claimed in claim 8, further comprising a controller, wherein the controller is electrically coupled to the power supply and the electromagnetic valve and configured for periodically switching on the cleaning system cleaning the solar panel.

10. The cleaning system as claimed in claim 8, wherein the axle and the washer are configured to move on the transparent protection panel back and forth to clean the transparent protection panel.

11. The cleaning system as claimed in claim 8, wherein the power supply is the solar panel.
